(19) United States
(12) Patent Application Publication
(10) Pub. No.: US 2003/0056224 A1
(43) Pub. Date: Mar. 20, 2003

(54) Method and apparatus for processing transport type B ATVEF data

(75) Inventor: Christopher J. Stone, Newtown, PA (US)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: General Instrument Corporation, Horsham, PA

(21) Appl. No.: 09/908,903

(22) Filed: Jul. 19, 2001

(51) Int. Cl. G06F 3/00; H04N 5/445; G06F 13/00; H04N 7/173

(52) U.S. Cl. 725/112; 725/110; 725/51

(57) ABSTRACT

Small consumer devices with limited memory resources, such as wireless devices for controlling set-top terminals, personal digital assistants (PDAs), or the like, are provided with the capability to access transport type B advanced television enhancement forum (ATVEF) data which is stored in a set-top terminal. Upon receiving a signal including transport type B ATVEF data, the set-top terminal extracts and stores the transport type B ATVEF data. The set-top terminal then parses through the data looking for any uniform resource locators (URLs) that contain a “lid:” protocol indicator, and reformats the “lid:” protocol indicator to an “http:” protocol indicator. The set-top terminal also substitutes the set-top terminal's Internet Protocol (IP) address in place of each of the URLs' current domain names.

### BACKGROUND OF THE INVENTION

1. Field of the Invention

The present invention generally relates to the use and processing of interactive television data for delivering enhanced television programming in a CATV environment.

2 Background Information

The Advanced Television Enhancement Forum (ATVEF) was formed in 1997 by a consortium of 14 leading companies in the television and computing industries. This group developed a public, worldwide specification for creating and delivering interactive TV (ITV) content. In 1999, the ATVEF Specification v1.1, r26 was finalized and published. The ATVEF Specification serves as a standard for creating enhanced, interactive television content and delivering that content to a range of television, set-top, and PC-based receivers. The ATVEF Specification uses existing Internet technologies to deliver enhanced TV programming over both analog and digital video systems using terrestrial, cable, satellite and Internet networks. The ATVEF Specification can be used in both one-way broadcast and two-way video systems, and is designed to be compatible with all international standards for both analog and digital video systems.

Television enhancements are comprised of three related data sources: announcements (delivered via SAP), content (delivered via UHTTP), and triggers (delivered via the trigger protocol over UDP). SAP (Session Announcement Protocol) is a protocol used for session announcements. UHTTP (Unidirectional Hypertext Transfer Protocol) is a simple, robust, one-way resource transfer protocol that is designed to efficiently deliver resource data in a one-way broadcast-only environment. This resource transfer protocol is appropriate for Internet Protocol (IP) multicast over a television vertical blanking interval (IPVBI), in IP multicast carried in MPEG-2, or in other unidirectional transport systems. The vertical blanking interval (VBI) of a television signal is a non-viewable portion of the television signal that can be used to provide point-to-multipoint IP data services which will relieve congestion and traffic in the traditional Internet access networks. UDP (User Datagram Protocol) is an Internet Standard transport layer connection-less protocol which adds a level of reliability and multiplexing to IP. IP is one of the communication languages used by computers connected to the Internet. IP datagrams may be transmitted using the VBI of a television signal.

Announcements are broadcast on a single well-known multicast address and have a time period for which they are valid. This time period is expressed via the “t=” and “a=tve-ends:” lines within the SDP record. SDP (Session Description Protocol) is intended for describing multimedia sessions for the purposes of session announcement, session invitation, and other forms of multimedia session initiation. Announcements also indicate the multicast address and port number that a client can listen in on to receive the content and triggers. The client is a processor (e.g., computer) that requests a Web page from a server. The announcement also contains information that the client can optionally use to help decide whether to automatically start receiving trigger and content information.

When the client sees a new enhancement, it knows that there will be data available on the given content and trigger addresses. The client may present the user with a choice to start receiving trigger and content information, or may do so automatically. The client implementation specifies what kind of user interface, if any, to present. After this confirmation (or automatic behavior) the client receives content and triggers, caching the content and parsing the triggers.

When the client first receives a trigger (containing a URL pointing to some enhancement content), the client may notify the user that the content is available or, alternatively, navigate to that content automatically. Clients may choose not to notify the user if they believe that they cannot display the enhancement, generally because the content referred to by the specified URL is not available.

When an enhancement has either been confirmed by the user, or has been started automatically, the enhancement is displayed. Only one enhancement may be displayed at a time. When new triggers associated with the current enhancement arrive, they are played or ignored depending on several conditions. If the URL of the trigger matches the URL of the current page and the trigger has a script attribute, the script is played. If there is no script, the trigger is ignored. If the URLs do not match and the trigger has a name attribute, the trigger is considered a new enhancement and is played, offered to the viewer, or ignored depending on other factors described below. If there is no name attribute, the trigger is ignored.

If a new enhancement is announced while an existing enhancement is being displayed, the client may present the user with the option to begin receiving that announcement data (content and triggers). Multiple enhancements may be received simultaneously, although only one may be displayed at a time. When the new enhancement is being received at the same time that an existing enhancement is being displayed, and the new enhancement delivers its first trigger, the client may have one of three behaviors:

(1) The client ignores the new enhancement trigger until the existing enhancement has been completed.

(2) The client presents a user with the opportunity to navigate to the new enhancement.

(3) The client automatically navigates to the new enhancement.

It may be important for some triggers to be able to send scripts to the current enhancement without presenting the user with the opportunity to navigate to that enhancement. In this case, no [name:] attribute should be included. This allows enhancements to enforce that the user view them from the beginning and not join in later when a subsequent trigger containing a script is received. If no [name:] attribute is found in the trigger, the user should not be presented with the opportunity to view the enhancement or automatically navigate there. The enhancement's data stream can be used to pre-load data by sending data before the first trigger that is sent with a [name:] attribute.

Content creators are encouraged to “shut down” their enhancements at the end of the related video content. This means that enhancements should navigate themselves (via trigger scripts or some other scripting mechanism) to full screen television (“tv:”) when the program or commercial ends. This will prevent content creators from displaying their enhancement over some unrelated broadcasts and reduce the likelihood of conflicts between producers. Content creators may wish to collaborate with the producers of subsequent programs or commercials to build a single enhancement that spans multiple video segments and may provide some enhanced user experience. When the time period specified by the announcement is over, clients may automatically end the enhancement or allow the user to continue viewing the enhancement over potentially unrelated video.

The ATVEF Specification provides content creators with a reliable definition of mandatory content support on all compliant receivers. In addition, any other kind of data content can be sent over ATVEF transport including HTML, VRML, Java, or even private data files. When a content creator wants to broadcast an enhancement to play on the maximum number of receivers, the data should conform to the ATVEF Specification. In the case where the content author knows the specific capabilities of the target receiver, data can be sent over ATVEF transport that is outside the ATVEF Specification including DHTML, Java, or even private data files.

Triggers are real-time events delivered for the enhanced TV program. Triggers allow users to turn on or off enhanced TV content. Receivers can use trigger arrival as a signal to notify users of enhanced content availability and enable the users to choose among enhancements. Triggers always include an URL, and may optionally also include a human-readable name, an expiration date, and a script. Triggers that include a “name” attribute may be used to initiate an enhancement either automatically, or with user confirmation. The initial top-level page for that enhancement is indicated by the URL in that trigger. Triggers that do not include a “name” attribute are not intended to initiate an enhancement, but should only be processed as events which affect (through the “script” attribute) enhancements that are currently active.

The “lid:” URL scheme enables content creators to assign unique identifiers to each resource relative to a given namespace. Thus the author can establish a new namespace for a set of content and then use simple, human-readable names for all resources within that space. The “lid:” scheme is used by the “Content-Location:” field in the UHTTP resource transfer header to identify resources that should be stored locally by a broadcast capable receiver platform and are not accessible via the Internet.

The syntax of the “lid:” URL is as follows: lid://{namespace-id}[/{resource-path}]. The {namespace-id} specifies a unique identifier (e.g. UUID or a domain name) to use as the namespace for this content or as a root for the URL. The {resource-path} names a specific resource within the namespace, and must follow the generic relative URL syntax. As with all UTRL schemes that support the generic relative URL syntax, this path component can be used alone as a relative URL, where the namespace is implied by a base URL specified for the content through other means.

While all compliant implementations of enhanced TV receivers support absolute URLs within the UIHTTP header and broadcast triggers, some implementations may not correctly process absolute URLs using the “lid:” scheme within HTML content. To ensure that HTML content is correctly interpreted by these receiving platforms, content should use only relative URLs in their HTML. Triggers use the full “lid:” URL to load the top level HTML page and that page uses relative URLs to refer to other resources.

The display of enhanced TV content consists of two steps: delivery of data resources (e.g. HTML pages) and display of named resources synchronized by triggers. All forms of ATVEF transport involve data delivery and triggers. The capability of networks for one-way and/or two-way communication drives the definition of two models of transport.

ATVEF defines two kinds of transport. Transport A is for delivery of triggers by the forward path and the pulling of data by a (required) return path. Transport B is for delivery of triggers and data by the forward path where the return path is optional.

Besides defining how ATVEF content is displayed and how the receiver is notified of new content, the ATVEF Specification also defines how content is delivered. Because a television or set-top terminal may or may not have a connection out to the Internet, the ATVEF Specification describes two distinct models for delivering content. These two content delivery models are commonly referred to as transports, and the two transports defined by ATVEF are referred to as transport type A and transport type B.

Transport type A is defined for ATVEF receivers that maintain a connection (commonly called a back-channel or return path) to the Internet. Generally, this network connection is provided by a dial-up modem, but may be any type of bi-directional access channel. Transport type A is a method for delivering only triggers without additional content. Since there is no content delivered with Transport type A, all data must be obtained over the back-channel, using the URLs passed with the triggers as a pointer to the content.

Transport type B provides for delivery of both ATVEF triggers and its associated content via the broadcast network. In this model, the broadcaster pushes content to a receiver, which will store it in the event that the user chooses to view it. Transport B uses announcements sent over the network to associate triggers with content streams. An announcement describes a content stream, and may include information regarding bandwidth, storage requirements, and language (enhancements may be delivered in multiple languages).

Since the receiver will, in most cases, need to store any content that will be displayed, it uses announcement information to make content storage decisions. For instance, if a stream requires more storage space than a particular receiver has available, the receiver may elect to discard some older streams, or it may elect not to store the announced stream. A drawback of this model is that if a person chooses to start watching a show near the end, there may not be time for the content to be streamed to the receiver, and the person will not be able to view some or all of the content.

A cable/satellite television set-top terminal has sufficient storage capacity to receive, decode, store, and display type B ATVEF data. However, smaller consumer electronic devices, such as wireless devices for controlling set-top terminals, personal digital assistants (PDAs), or the like, have limited storage space, are not able to store transport type B ATVEF data, and thus are not able to display any content associated with a program that utilizes transport type B ATVEF data.

### SUMMARY OF THE INVENTION

The present invention utilizes the storage space, network capabilities, and processing power of a set-top terminal to provide smaller consumer devices with access to transport type B ATVEF data which is stored on the set-top terminal. In essence, the present invention enables the set-top terminal to “convert” transport type B ATVEF data into transport type A ATVEF data.

The present invention includes a method which is implemented in a local device that processes transport type B advanced television enhancement forum (ATVEF) data. A signal including transport type B ATVEF data is received. The type B ATVEF data is extracted and stored. The type B ATVEF data is parsed through to find uniform resource locators (URLs) that include a first resource protocol indicator. The first resource protocol indicator in each URL is changed to a second resource protocol indicator, and a domain name in each URL is changed to an Internet Protocol (IP) address associated with the local device.

The present invention also includes apparatus for processing transport type B advanced television enhancement forum (ATVEF) data. In one embodiment, the apparatus is a CATV system. The apparatus includes at least one receiver, demodulator and memory device, and a processor. The receiver receives a signal including transport type B ATVEF data. The decoder and demodulator are in communication with the receiver. The memory device stores data processed by at least one of the decoder and the demodulator. The processor instructs at least one of the decoder and the demodulator to extract the type B ATVEF data and store the extracted data in the memory device. The processor parses through the type B ATVEF data to find uniform resource locators (URLs) that include a first resource protocol indicator. The processor changes the first resource protocol indicator in each URL to a second resource protocol indicator. The processor changes a domain name in each URL to an Internet Protocol (IP) address associated with the local device. The present invention makes type B ATVEF data available to a remote device in communication with the apparatus without the remote device having to permanently store the type B ATVEF data.

The present invention may transmit at least one ATVEF trigger to the remote device. The remote device may transmit a request to the local device for content, in response to a user clicking on a hyperlink associated with the trigger, the hyperlink including a URL with the IP address associated with the local device. The local device may retrieve the requested content from storage and transmit the requested content to the remote device.

The remote device may then present the requested content to the user. The local device may be a set-top terminal. The remote device may control the set-top terminal. The remote device may be one of a personal digital assistant (PDA) and an Internet appliance. The first resource protocol indicator may be “lid://” and the second protocol resource indicator may be “http://.”

### BRIEF DESCRIPTION OF THE DRAWINGS

The following detailed description of preferred embodiments of the present invention would be better understood when read in conjunction with the appended drawings. For the purpose of illustrating the present invention, there are shown in the drawings embodiments which are presently preferred. However, the present invention is not limited to the precise arrangements and instrumentalities shown. In the drawings:

FIG. 1 shows a local device (e.g., a set-top terminal) that carries out a “lid:” to “http:” reformatting process in accordance with the present invention.

FIG. 2 shows a set-top terminal in communication with a remote device in accordance with the present invention.

FIGS. 3A and 3B, taken together, show a flow chart of a method used in accordance with the present invention.

FIG. 4 shows a data flow diagram in accordance with the present invention.

FIG. 5 shows the internal configuration of a set-top terminal used in conjunction with the present invention.

### DETAILED DESCRIPTION OF THE INVENTION

The present invention stores transport type B ATVEF data locally on a local device (e.g., set-top terminal), modifies various data contained within the ATVEF data, notifies devices connected to the set-top terminal of the presence of the locally stored ATVEF data, allows the connected devices to have access to the locally stored ATVEF data, and forwards specific parts of the ATVEF data to other devices connected to the set-top terminal, as requested by the devices. Transport type B ATVEF data consists of three components: 1) announcement, 2) content, and 3) triggers.

In accordance with the present invention, on the receipt of an announcement, the local device extracts and decodes the data in accordance to the ATVEF Specification. The local device then parses the announcement data and obtain the multicast IP address and ports for the content and triggers associated with the announcement. The local device packetizes the announcement in accordance to the ATVEF Specification and broadcasts the announcement, in accordance to the ATVEF Specification, via the local device's I/O ports (e.g. USB, 10/100Base-T, or the like).

In accordance with the present invention, on receipt of content on the specified IP and port, the local device extracts all of the data as defined by the Multipurpose Internet Mail Extensions (MIME) type of the content. The local device locally stores the extracted data in accordance with the Content-Location parameters defined by the MIME type.

Content data of MIME type (i.e. Content-Type) text/html is further processed such that Local Identifier URL Schemes (i.e. “lid:”) are reformatted as Hypertext Transfer Protocol (i.e. “http:”) URLs. When specifying the HTTP reference, the local device utilizes an IP address that is known to the local device in place of the “lid:” namespace-id. This IP address may be assigned to the local device by an ISP or may be a local IP address that the local device generates on its own.

In accordance with the present invention, on receipt of a trigger on the specified IP and port, the local device extracts and decodes the trigger, in accordance to the ATVEF Specification. The local device parses through the trigger and reformat “lid:” URLs as “http:” URLs. After the trigger is parsed, the local device packetizes the trigger as a Type B ATVEF trigger and broadcast, via the local device's I/O ports (e.g. USB, 10/100Base-T, etc), the trigger on the same-multicast IP address and port as defined in the announcement.

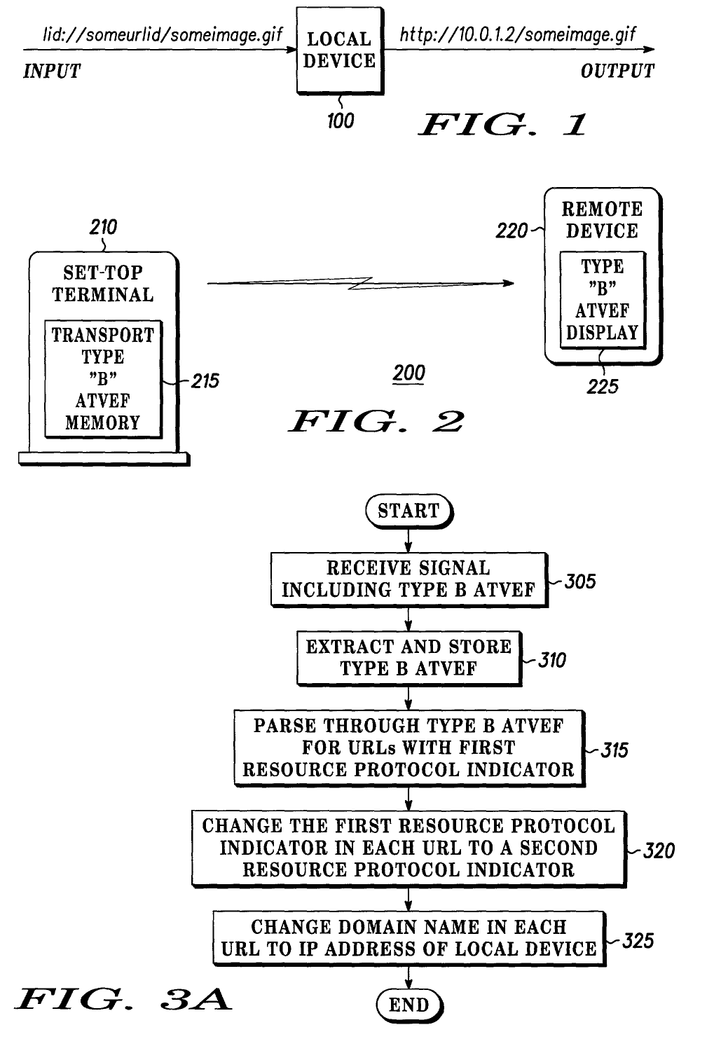

Referring to FIG. 1, a local device (e.g., a set-top terminal) 100 receives transport type B ATVEF data via an input port to the local device. URLs in the ATVEF data containing a first resource protocol indicator “lid://” and domain name “someurlid,” such as in the hyperlink lid://someurlid/someimage.gif, are changed to a second resource protocol indicator “http://” and new domain name “10.0.1.2,” respectively, such that a reformatted hyperlink http://10.0.1.2/someimage.gif is outputted from an output port of the local device 100. The new domain name 10.0.1.2 is the local IP address of the local device 100.

Referring to FIG. 2, a CATV system 200 comprising a set-top terminal 210 and a remote device 220 is shown. Transport type B ATVEF data is stored in a memory 215 within the set-top terminal 210. In the drawing, the remote device 220 is depicted as being a wireless device in communication with the set-top terminal 210. The remote device 220 has a display 225 for displaying transport type B ATVEF data received from the set-top terminal 210 without permanently storing the ATVEF data. The remote device 220 may be one of a PDA and an Internet appliance.

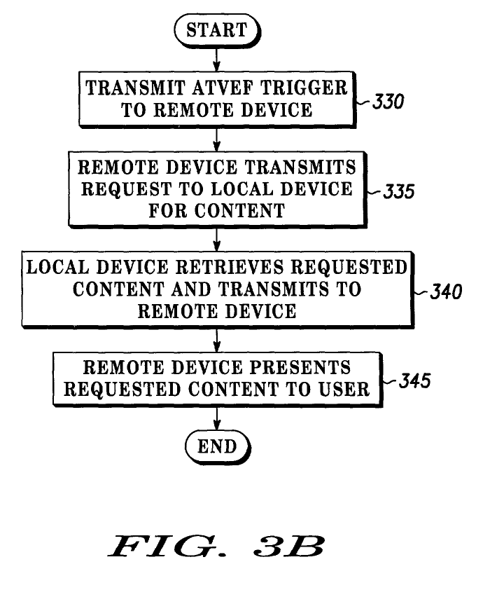

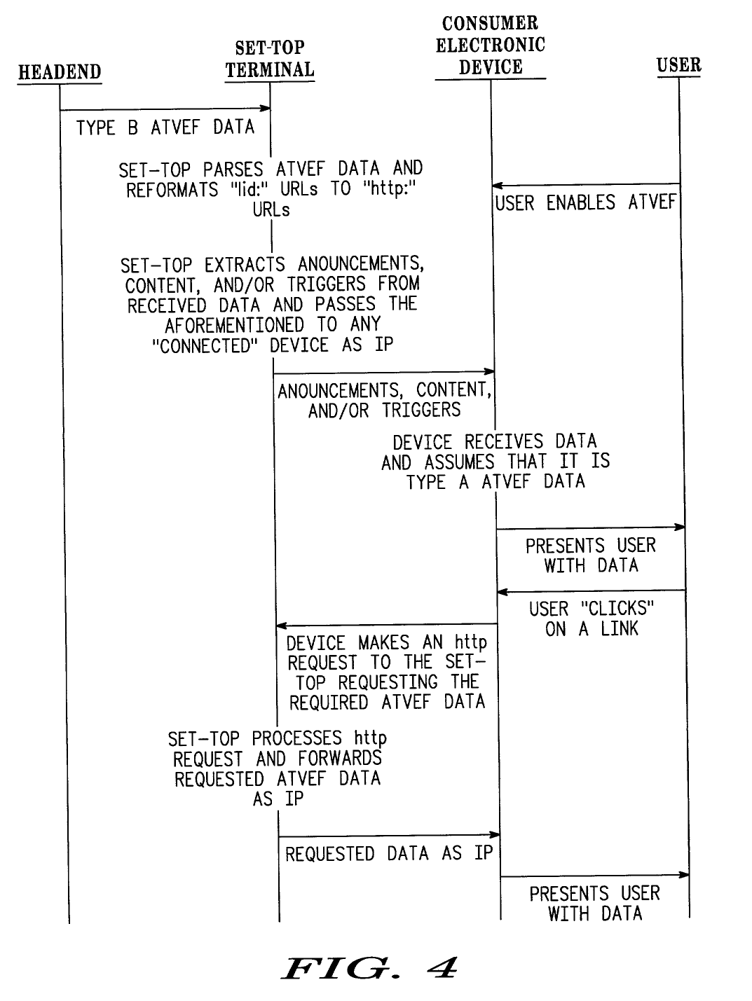

Referring to FIGS. 2 and 3A, a method in accordance with the present invention is implemented in a CATV system 200 in a set-top terminal 210 processes transport type B advanced television enhancement forum (ATVEF) data. In block 305, a signal including transport type B ATVEF data is received by set-top terminal 210. In block 310, the type B ATVEF data is extracted and stored in memory 215 of set-top terminal 210. In block 315, the type B ATVEF data is parsed through to find uniform resource locators (URLs) that include a first resource protocol indicator. In block 320, the first resource protocol indicator in each URL is changed to a second resource protocol indicator. In block 325, a domain name in each URL is changed to an Internet Protocol (IP) address associated with the set-top terminal 210.

Referring to FIGS. 2 and 3B, a method in accordance with the present invention is implemented in the CATV system 200 in which the set-top terminal 210 is communicating with the remote device 220. The present invention makes type B ATVEF data available to the remote device 220 without the remote device 220 having to permanently store the type B ATVEF data. In block 330, the local device 210 transmits at least one ATVEF trigger to the remote device 220. In block 335, the remote device 220 transmits a request to the local device 210 for content, in response to a user clicking on a hyperlink associated with the trigger, the hyperlink including a URL with the IP address associated with the local device 210. In block 340, the local device 210 retrieves the requested content from memory 215 and transmits the requested content to the remote device 220. The remote device 220 then presents the requested content to the user via a display 225.

Referring to FIG. 4, signals flowing between a headend, a set-top terminal, a consumer electronic device, and actions made by a user of the consumer electronic device (e.g., remote device 220), are illustrated in accordance with the present invention. A signal including transport type B ATVEF data is transmitted by a headend in a CATV network and received by set-top terminal 210. The set-top terminal parses the ATVEF data and reformats “lid:” URLs to “http:” URLs. A user of the consumer electronic device enables the display of transport type B ATVEF data without storing it in the consumer electronic device.

Upon receipt of the broadcast ATVEF data, a user of the present invention may be notified that ATVEF data is available. If the user opts to interact with or view the ATVEF data, then the device will initiate the appropriate HTTP connection with the set-top terminal utilizing the IP address supplied with the broadcast ATVEF data. At this point, the set-top terminal is acting as an HTTP server for the devices that are in communication with the set-top terminal, allowing the devices to access the locally stored ATVEF data via the HTTP protocol.

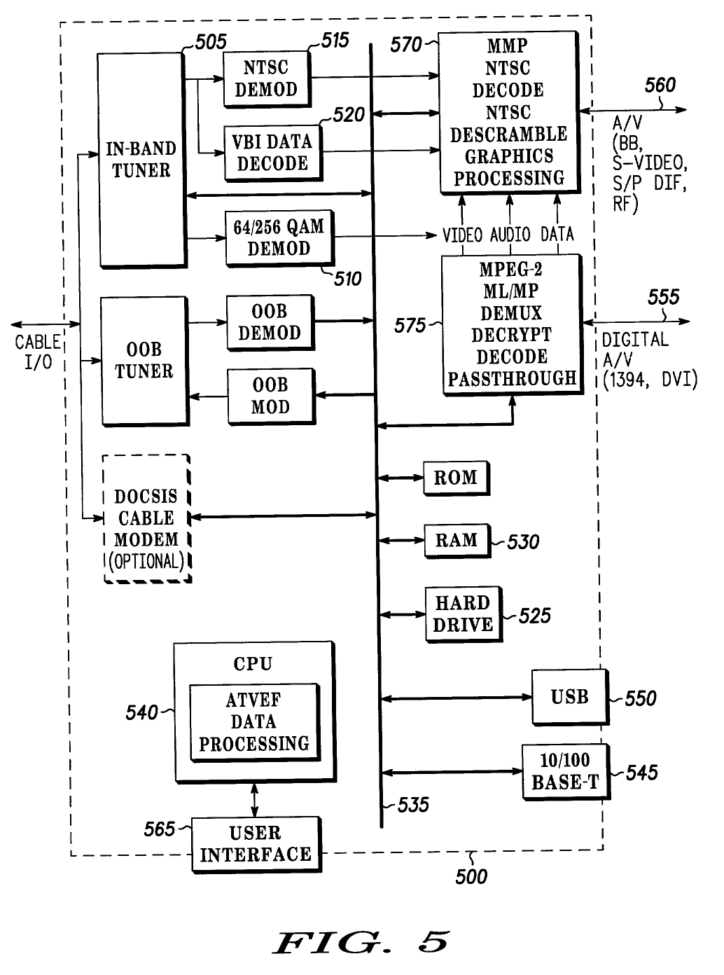

Referring to FIG. 5, apparatus (e.g., a set-top terminal) 500 in accordance with the present invention comprises an in-band tuner 505 which receives a signal at a particular carrier frequency via a cable I/O port. The signal includes transport type B ATVEF data transmitted from a Cable Television (CATV) and/or a Direct Broadcast Satellite (DBS) service node. The in-band tuner 505 passes the received signal to a 64/256 QAM demodulator 510 for processing digital transmissions, and/or a NTSC demodulator 515 and VBI data decoder 520 for processing analog transmissions. The decoded ATVEF data is stored locally within the apparatus utilizing a hard drive (HDD) 525, RAM 530, or any other type of digital storage media. Coupled to the in-band tuner 505 via a bus 535 is a computer processing unit (CPU) 540 which directs the in-band tuner 505 as to which frequency it should be tuned to. CPU 540 is made aware of the presence of the ATVEF data. A function/application running within the CPU 540 parses through the ATVEF data stored in memory, reformats the ATVEF data and broadcasts the appropriate data via the I/O ports 545, 550, 555, 560 to all UDP/IP capable devices in communication with apparatus 500. Requests for transport type B ATVEF data may be received from a remote device via user interface 565.

In the case where the transport type B ATVEF data is embedded within lines 10 to 20 of the VBI (i.e. IP over VBI), the data is extracted via the VBI data decoder 520 and forwarded to a multi-media processor (MMP) 570. The MMP 570 verifies that the data is in the form of ATVEF data and processes it accordingly for utilization with a television, which is connected to the apparatus.

In the case where the transport type B ATVEF data is embedded within an MPEG-2 transport stream (i.e. IP of MPEG), the transport stream is demodulated by the 64/256 QAM demodulator 520 and forwarded to an MPEG-2 processor 575. The MPEG-2 processor 575 demultiplexes the demodulated transport stream, parses and decodes the elementary streams associated with IP over MPEG packet identifications (PIDs), and forwards the decoded ATVEF data to the MMP 570.

The following example depicts the data associated with a simulated ATVEF Type B transmission in accordance with the present invention. The terminologies and data structures illustrated are known to those familiar to the art and as such will not be explained.

Text Payload of ATVEF Announcement

v=0

o=12345 67890 IN IP4 tve.somebroadcaster.com

s=Some TV Show

i=A TV show about something

e=support@somebroadcaster.com

a=type:tve

a=tve-level: 1.0

a=tve-ends: 1200

m=data 12345/2 tve-file/tve-trigger

c=IN IP4 223.1.2.33/127

b=CT: 28

a=tve-size: 5

MIME Entity Consisting of ATVEF Content

Content-Base: lid://somebroadcaster.com/someshow1
Content-Length: 1234
Content-Type: Multipart/Related; boundary=example 123456
--example123456
Content-Location: main.html
Content-Length: 500
Content-Type: text/html
<HTML>
<READ>
<TITLE>Some TV Show</TITLE>
<BODY bgcolor = #999999>
<TABLE>

<TR>

<TD align=TOP>

<IMG name = “image1.gif” src =

“lid://somebroadcaster.com/someshow1/image1.gif”></A><BR>

<IMG name = “image2.gif” src =

“lid://somebroadcaster.com/someshow1/image2.gif”></A>

</TD>
<TD>
<A href = “tv:”><IMG name = “TV” src = “tv:”></A>
</TD>

</TR>

</TABLE>
</BODY>
</HTML>
--example123456
Content-Location: image1.gif
Content-Length: 1500
Content-Type: image/gif
(This section would normally contain the binary data associated with the GIF image. This data
has been eliminated for the sake of conserving space).
--example123456
Content-Location: image2.gif
Content-Length: 1500
Content-Type: image/gif
(This section would normally contain the binary data associated with the GIF image. This data
has been eliminated for the sake of conserving space).
--example123456

Text Payload of First ATVEF Trigger:

<lid://somebroadcaster.com/someshow1/main.html>[name:Some TV Show]

Text Payload of Second ATVEF Trigger:

<tv:>

The text payload of the ATVEF Announcement would be utilized to obtain the broadcast IP address (i.e. 223.1.2.33) and ports (i.e. 12345 and 12346) associated with the Content and Triggers. Once the data was obtained, the Announcement would repacketized and broadcast via the set-top terminal's I/O ports.

The MIME entity consisting of ATVEF Content would be extracted and stored locally utilizing a directory structure as follows:

/someshow1/main.html

/someshow1/image1.gif

/someshow1/image2.gif

The main.html text/html entity would be decoded and the “lid:” URLs reformatted as “http:” URLs utilizing an IP address of 10.0.1.3, which is associated with the set-top terminal. The main.html would then be encoded as MIME type text/html and stored in the current location replacing the original copy/version of the text. The reformatted version of the main.html data associated with the previous example follows:

Content-Location: main.html
Content-Length: 500
Content-Type: text/html
<HTML>
<HEAD>
<TITLE>Some TV Show</TITLE>
<BODY bgcolor = #999999>
<TABLE>

<TR>

<TD align=TOP>

<IMG name = “image1.gif” src =

“http://10.0.1.3/someshow1/image1.gif”></A><BR>

<IMG name = “image2.gif” src =

“http://10.0.1.3/someshow1/image2.gif”></A>

<TD>
<TD>
<A href=“tv:”><IMG name = “TV” src = “tv:”></A>
</TD>

</TR>

</TABLE>
</BODY>
</HTML>

The text payload of first ATVEF Trigger would be decoded and the “lid:” URLs reformatted as “http:” URLs utilizing an IP address of 10.0.1.3, which is associated with the set-top terminal. The trigger would then be repacketized and broadcast via the set-top terminals I/O ports.

Reformatted Text Payload of First ATVEF Trigger:

<http://10.0.1.3/someshow1/main.html>[name:Some TV Show]

The second trigger does not contain a “lid:” reference and as such would not be reformatted. After inspection the trigger would be repacketized and broadcast via the set-top terminals I/O ports.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. In a local device which processes transport type B advanced television enhancement forum (ATVEF) data, a method comprising:
(a) receiving a signal including transport type B ATVEF data;
(b) extracting and storing the type B ATVEF data;
(c) parsing through the type B ATVEF data to find uniform resource locators (URLs) that include a first resource protocol indicator, the URLs including a domain name;
(d) changing the first resource protocol indicator in each URL to a second resource protocol indicator; and
(e) changing the domain name in each URL to an Internet Protocol (IP) address associated with the local device, whereby type B ATVEF data is available to a remote device in communication with the local device without the remote device having to permanently store the type B ATVEF data.

2. The method of claim 1, further comprising:
(f) transmitting at least one ATVEF trigger to the remote device;
(g) the remote device transmitting a request to the local device for content, in response to a user clicking on a hyperlink associated with the trigger, the hyperlink including a URL with the IP address associated with the local device;
(h) the local device retrieving the requested content from storage and transmitting the requested content to the remote device; and
(i) the remote device presenting the requested content to the user.

3. The method of claim 2, wherein the local device is a set-top terminal.

4. The method of claim 3, wherein the remote device controls the set-top terminal.

5. The method of claim 2, wherein the remote device is one of a personal digital assistant (PDA) and an Internet appliance.

6. The method of claim 1, wherein the first resource protocol indicator is “lid://” and the second protocol resource indicator is “http://.”

7. Apparatus for processing transport type B advanced television enhancement forum (ATVEF) data, comprising:
(a) at least one receiver which receives a signal including transport type B ATVEF data;
(b) at least one decoder in communication with the receiver;
(c) at least one demodulator in communication with the receiver;
(d) at least one memory device which stores data processed by at least one of the decoder and the demodulator; and
(e) a processor, wherein the processor:
(i) instructs at least one of the decoder and demodulator to extract the type B ATVEF data and store the extracted data in the memory device;
(ii) parses through the type B ATVEF data to find uniform resource locators (URLs) that include a first resource protocol indicator, the URLs including a domain name;
(iii) changes the first resource protocol indicator in each URL to a second resource protocol indicator; and
(iv) changes the domain name in each URL to an Internet Protocol (IP) address associated with the local device, whereby type B ATVEF data is available to a remote device in communication with the apparatus without the remote device having to permanently store the type B ATVEF data.

8. The apparatus of claim 7, wherein the local device is a set-top terminal.

9. The apparatus of claim 8, wherein the remote device controls the set-top terminal.

10. The apparatus of claim 7, wherein the remote device is one of a personal digital assistant (PDA) and an Internet appliance.

11. The apparatus of claim 7, wherein the first resource protocol indicator is “lid://” and the second protocol resource indicator is “http://.”

12. A CATV system for processing transport type B advanced television enhancement forum (ATVEF) data, comprising:
(a) a remote device; and
(b) a local device which extracts type B ATVEF data from a signal received by the local device, stores the extracted data, parses through the type B ATVEF data to find uniform resource locators (URLs) that include a first resource protocol indicator, changes the first resource protocol indicator in each URL to a second resource protocol indicator, and changes a domain name in each URL to an IP address associated with the local device, whereby type B ATVEF data stored in the local device is available to the remote device without permanently storing the type B ATVEF data in the remote device.

13. The CATV system of claim 12, wherein the local device is a set-top terminal.

14. The CATV system of claim 13, wherein the remote device controls the set-top terminal.

15. The CATV system of claim 12, wherein the remote device is one of a personal digital assistant (PDA) and an Internet appliance.

16. The CATV system of claim 12, wherein the first resource protocol indicator is “lid://” and the second protocol resource indicator is “http://.”

17. An article of manufacture for use in a local device which processes transport type B advanced television enhancement forum (ATVEF) data, the article of manufacture comprising a computer-readable medium holding computer-executable instructions for performing a method comprising:
(a) receiving a signal including transport type B ATVEF data;
(b) extracting and storing the type B ATVEF data;
(c) parsing through the type B ATVEF data to find uniform resource locators (URLs) that include a first resource protocol indicator, the URLs including a domain name;
(d) changing the first resource protocol indicator in each URL to a second resource protocol indicator; and
(e) changing the domain name in each URL to an Internet Protocol (IP) address associated with the local device, whereby type B ATVEF data is available to a remote device in communication with the local device without the remote device having to permanently store the type B ATVEF data.

18. The article of manufacture of claim 17, wherein the local device is a set-top terminal.

19. The article of manufacture of claim 18, wherein the remote device controls the set-top terminal.

20. The article of manufacture of claim 17, wherein the remote device is one of a personal digital assistant (PDA) and an Internet appliance.

21. The article of manufacture of claim 17, wherein the first resource protocol indicator is “lid://” and the second protocol resource indicator is “http://.”
